(19) United States
(12) Patent Application Publication
(10) Pub. No.: US 2024/0418507 A1
(43) Pub. Date: Dec. 19, 2024

(54) MULTI-POSITIONING METHOD AND DEVICE

(71) Applicant: NEUBILITY INC., Seoul (KR)

(72) Inventors: Moon Ki KIM, Seoul (KR); Sang Min LEE, Seoul (KR); Kee Hyuk KANG, Seoul (KR)

(21) Appl. No.: 18/700,112

(22) PCT Filed: Sep. 6, 2022
(86) PCT No.: PCT/KR2022/013374

§ 371 Date: Apr. 10, 2024

(30) Foreign Application Priority Data
Dec. 6, 2021 (KR) 10-2021-0173008

(51) Int. Cl. G01C 3/06; G01C 1/00; G01C 15/00

(52) U.S. Cl. CPC G01C 3/06; G01C 1/00; G01C 15/00

(57) ABSTRACT

Provided is a multiple positioning method and apparatus including a node setting part for setting at least three anchor nodes whose positions are known to at least one unknown node whose position is to be obtained; an information acquisition part for acquiring distance information between each of unknown nodes and each of anchor nodes, distance information between unknown nodes and coordinate information of each of anchor nodes; and a coordinate calculation part for calculating coordinates of each of the unknown nodes based on the distance information between each of the unknown nodes and each of the anchor nodes, the distance information between the unknown nodes and the coordinate information of each of the anchor nodes.

### TECHNICAL FIELD

The present invention relates to a position measurement method, and more particularly a multiple positioning method and apparatus.

### BACKGROUND ART

Recently, many sensors that can provide distance information between apparatuses, such as UWB, BLE, and WiFi, are being developed with the development of sensor technology. Accordingly, in addition to distance information between anchor nodes, which are points whose positions are known, and unknown nodes, which are points whose positions are to be obtained, when calculating a position, it is possible to additionally use distance information between the unknown nodes. Nevertheless, since a position has been calculated using only distance information between anchor nodes and unknown nodes, accuracy and convergence are relatively low.

In addition, the same principle can be applied to multiple camera positioning using distance information between cameras rather than positioning using distance information between sensors. However, also in this case, single camera positioning has lower accuracy and convergence than positioning using distance relationships between multiple cameras and matching points (i.e., anchor nodes) in a wider range of directions. In addition, calculating a position using the distance information between a camera and a matching point has lower accuracy and robustness than calculating a position using angle information that is information before obtaining distance information.

### [Related Art Documents]

### [Patent Documents]

(Patent Document 1) Korean Patent No. 10-1565799 B1

(Patent Document 2) Korean Patent No. 10-1350389 B1

### Disclosure

### Technical Problem

Therefore, the present invention has been made in view of the above problems, and it is one object of the present invention to provide a multiple positioning method and apparatus capable of improving the accuracy of position measurement for unknown nodes.

It is another object of the present invention to provide a multiple positioning method and apparatus capable of increasing the convergence of a position measurement result.

It is yet another object of the present invention to provide a multiple positioning method and apparatus capable of calculating a position even if the number of matching points is insufficient in the case of single camera positioning.

### Technical Solution

In accordance with an aspect of the present invention, the above and other objects can be accomplished by the provision of a multiple positioning apparatus, including: a node setting part for setting at least three anchor nodes whose positions are known to at least one unknown node whose position is to be obtained; an information acquisition part for acquiring distance information between each of unknown nodes and each of anchor nodes, distance information between unknown nodes and coordinate information of each of anchor nodes; and a coordinate calculation part for calculating coordinates of each of the unknown nodes based on the distance information between each of the unknown nodes and each of the anchor nodes, the distance information between the unknown nodes and the coordinate information of each of the anchor nodes.

Preferably, each of the unknown nodes is a sensor apparatus.

Preferably, the coordinate calculation part calculates coordinates of each of the unknown nodes by assigning different weights to each of the distance information between each of the unknown nodes and each of the anchor nodes, the distance information between the unknown nodes and the coordinate information of each of the anchor nodes.

Preferably, the coordinate calculation part estimates coordinates of each of the unknown nodes by applying extended Kalman filter to the distance information between each of the unknown nodes and each of the anchor nodes, the distance information between the unknown nodes and the coordinate information of each of the anchor nodes.

In accordance with another aspect of the present invention, there is provided a multiple positioning apparatus, including: a node setting part for setting at least three anchor nodes whose positions are known to at least one unknown node whose position is to be obtained; an information acquisition part for acquiring distance and angle information between each of unknown nodes and each of anchor nodes, distance information between unknown nodes and coordinate information of each of anchor nodes; and a coordinate calculation part for calculating coordinates of each of the unknown nodes based on the distance and angle information between each of the unknown nodes and each of the anchor nodes, the distance information between the unknown nodes and the coordinate information of each of the anchor nodes.

Preferably, each of the unknown nodes is a camera.

Preferably, each of the anchor nodes represents specific points in an image captured by the camera.

Preferably, the coordinate calculation part calculates coordinates of each of the unknown nodes by assigning different weights to each of the distance information between each of the unknown nodes and each of the anchor nodes, the distance information between the unknown nodes and the coordinate information of each of the anchor nodes.

Preferably, the coordinate calculation part estimates coordinates of each of the unknown nodes by applying extended Kalman filter to the distance and angle information between each of the unknown nodes and each of the anchor nodes, the distance information between the unknown nodes and the coordinate information of each of the anchor nodes.

In accordance with yet another aspect of the present invention, there is provided a multiple positioning method, including: setting, by a multiple positioning apparatus, at least three anchor nodes whose positions are known to at least one unknown node whose position is to be obtained; acquiring, by the multiple positioning apparatus, distance information between each of unknown nodes and each of anchor nodes, distance information between unknown nodes and coordinate information of each of anchor nodes; and calculating, by the multiple positioning apparatus, calculating coordinates of each of the unknown nodes based on the distance information between each of the unknown nodes and each of the anchor nodes, the distance information between the unknown nodes and the coordinate information of each of the anchor nodes.

### Advantageous Effects

As apparent above, a more accurate position can be calculated by additionally using distance information between the unknown nodes. In addition, single camera positioning has low accuracy because matching points exist only in a limited direction of the camera, while multiple camera positioning can use points in a wider direction according to the distribution of cameras' gaze directions, so more accurate positioning can be obtained. In addition, when angle information is used instead of distance information, position accuracy is improved because more information coupled with each other can be obtained even if the number of matching points is the same.

In addition, when positions are calculated individually without using distance information between unknown nodes, the results often do not converge. However, convergence can be increased by using distance information between the unknown nodes.

Further, in the case of single camera positioning, the position cannot be calculated if the number of matching points is insufficient. However, the position can be calculated through multiple camera positioning even if the matching points of some cameras are insufficient. In addition, by using angle information instead of distance information, the number of information that can be used increases compared to when using distance information, so the position can be calculated even if the number of matching points is insufficient.

### DESCRIPTION OF DRAWINGS

FIG. 1 is a block diagram illustrating schematic constructions inside a multiple positioning apparatus according to an embodiment of the present invention.

FIG. 2 illustrates a method of calculating the coordinates of unknown nodes using both distance information between the unknown nodes and an anchor node and distance information between the unknown nodes during multiple positioning according to the embodiment.

FIG. 3 illustrates a method of calculating the coordinates of an unknown node using an angle measurement value when multiple camera positioning according to the embodiment.

FIG. 4 is a block diagram illustrating an example of hardware capable of realizing the function of a multiple positioning apparatus according to an embodiment of the present invention.

FIG. 5 is a flowchart illustrating a multiple positioning method when the unknown node according to an embodiment of the present invention is a sensor apparatus.

FIG. 6 is a flowchart illustrating a multiple positioning method when an unknown node according to an embodiment of the present invention is a camera.

[Description of Reference Numerals]

| | |
|---|---|
| 100: | multiple positioning apparatus |
| 110: | node setting part |
| 120: | information acquisition part |
| 130: | coordinate calculation part |

### Best Mode

The terminology used herein is for the purpose of describing particular embodiments only and is not intended to be limiting of the present invention. Unless otherwise defined, all technical terms used herein have the same meaning as commonly understood by one of ordinary skill in the art to which this present invention belongs and will not be interpreted in overly wide or narrow sense unless expressly so defined herein. If a term used herein is a wrong term by which one of ordinary skill in the art cannot correctly understand the present invention, the wrong term should be replaced by a technical term by which one of ordinary skill in the art can correctly understand the present invention. It will be further understood that terms, such as those defined in commonly used dictionaries, should be interpreted as having a meaning that is consistent with their meaning in the context of the relevant art and will not be interpreted in an overly narrow sense.

As used herein, the singular forms “a,” “an” and “the” are intended to include the plural forms as well, unless the context clearly indicates otherwise. It will be further understood that the terms “comprises” or “comprising” are not intended to include all elements or all steps described herein, but do not preclude exclusion of some elements or steps described herein or addition of one or more other elements or steps.

In addition, the suffixes “module” and “part” for components used in this specification are given or used interchangeably only considering the ease of writing the specification, and do not have distinct meanings or roles in themselves.

It will be understood that, although the terms first, second, third etc. may be used herein to describe various elements, these elements should not be limited by these terms. These terms are only used to distinguish one element from another element. For example, a first element may be termed a second element and a second element may be termed a first element without departing from the teachings of the present invention.

Meanwhile, an unknown node used in this specification represents a node whose position is to be obtained, and an anchor node represents a node whose position is known. Here, the unknown node may be a sensor apparatus or a camera.

Additionally, in multiple camera positioning, an anchor node can be called a matching point. Specifically, a screen captured as a camera moves is saved, and certain points (e.g., structures, etc.) in the saved screen are saved to create a map. Here, certain points represent matching points.

Hereinafter, the present invention will be described in detail by explaining exemplary embodiments of the invention with reference to the attached drawings. The same reference numerals in the drawings denote like elements, and a repeated explanation thereof will not be given.

In the description of the present invention, certain detailed explanations of related art are omitted when it is deemed that they may unnecessarily obscure the essence of the invention. The features of the present invention will be more clearly understood from the accompanying drawings and should not be limited by the accompanying drawings.

First of all, before explaining the present invention, multiple positioning can be divided into a case using sensors and a case using cameras. In both cases, methods of calculating positions are similar, but the types and number of information used in the calculation are different. In the case of multiple sensor positioning, distance information exists between all anchor nodes and all unknown nodes in a general state. However, in the case of multiple camera positioning, there is only distance information or angle information with matching points matched by each camera, and there is no distance information or angle information with matching points matched by other cameras. In other words, each camera can only know the distance or angle to the matching points that exist on the screen it is looking at. As such, multiple sensor positioning and multiple camera positioning differ in the type and number of information used for position calculation.

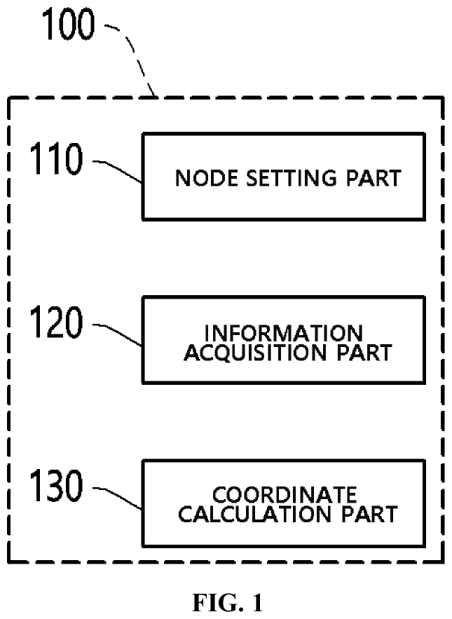

FIG. 1 is a block diagram illustrating schematic constructions inside a multiple positioning apparatus according to an embodiment of the present invention.

Referring to FIG. 1, a multiple positioning apparatus 100 according to the present invention may include a node setting part 110, an information acquisition part 120 and a coordinate calculation part 130.

The node setting part 110 sets at least three anchor nodes for at least one unknown node.

When unknown nodes are sensor apparatuses, the information acquisition part 120 acquires distance information between each of the unknown nodes and each of the anchor nodes, distance information between the unknown nodes and coordinate information of each of the anchor nodes.

The coordinate calculation part 130 calculates the coordinates of each of the unknown nodes based on distance information between each of the unknown nodes and each of the anchor nodes, distance information between the unknown nodes and coordinate information of each of the anchor nodes.

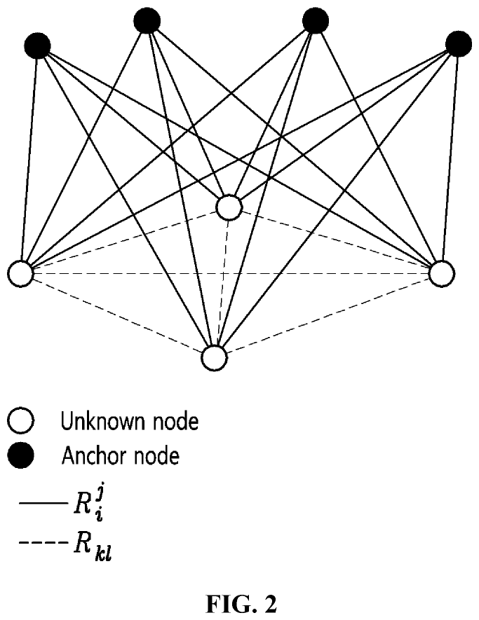

In addition, the coordinate calculation part 130 may calculate the coordinates of each of the unknown nodes by assigning different weights to distance information between each of the unknown nodes and each of the anchor nodes, distance information between the unknown nodes and coordinate information of each of the anchor nodes (weighted least square). Hereinafter, a method of calculating the coordinates of each of the unknown nodes using the weighted least square according to this embodiment is described with reference to FIG. 2.

In this embodiment, a positional relationship between an anchor node and an unknown node may be expressed by Mathematical Equation 1, and a positional relationship between an unknown node and an unknown node may be expressed by Mathematical Equation 2:

$${\vec{P}}_{i} \cdot {e}_{i}^{j} = {\vec{P}}^{j} {e}_{i}^{j} - {R}_{i}^{j} \begin{matrix}i : 1 , … , {N}_{U} \\ j : 1 , … , {N}_{A}\end{matrix} \qquad [ Mathematical Equation 1 ]$$

$$( {\vec{P}}_{k} - {\vec{P}}_{l} ) \cdot {e}_{kl} = - {R}_{kl} \begin{matrix}k : 1 , … , {N}_{U} - 1 \\ l : 2 , … , {N}_{U} ( l > k )\end{matrix} \qquad [ Mathematical Equation 2 ]$$

where R represents a distance, e represents a unit vector, P represents a position, N_{A} represents the number of anchor nodes, and Nu represents the number of unknown nodes.

The coordinate calculation part 130 calculates the coordinates of each of the unknown nodes by repeatedly substituting x into Mathematical Equation 3 under the condition

$${dN}_{U} \leq {N}_{A} {N}_{U} + \frac{{N}_{U} ( {N}_{U} - 1 )}{2}$$

that is an equation the required number of anchor nodes and unknown nodes:

$$X = {( {A}^{T} WA )}^{- 1} {A}^{T} WB \qquad [ Mathematical Equation 3 ]$$

where X represents a vector that collects position vectors of unknown nodes to be obtained and may be expressed as

$$X = {[ \begin{matrix}{\vec{P}}_{1} \\ … \\ i = i + 1 \\ {\vec{P}}_{{N}_{U}}\end{matrix} ]}_{{dN}_{U} \times 1.}$$

A represents a matrix composed of unit vectors remaining after subtracting X from the left side of Mathematical Equations 1 and 2 and may be expressed as

$$A = {[ \begin{matrix}{A}_{anchor} \\ {A}_{unknown}\end{matrix} ]}_{( {N}_{A} {N}_{U} + \frac{{N}_{U} ( {N}_{U} - 1 )}{2} ) \times {dN}_{U} .}$$

B represents a matrix consisting of terms remaining on the right side of Mathematical Equations 1 and 2 and may be expressed as

$$B = {[ \begin{matrix}{B}_{anchor} \\ {B}_{unknown}\end{matrix} ]}_{( {N}_{A} {N}_{U} + \frac{{N}_{U} ( {N}_{U} - 1 )}{2} ) \times 1} .$$

Here, expressions consisting of N_{A} and N_{U} represent the sizes of each matrix and vector.

In addition, the coordinate calculation part 130 may estimate the coordinates of each of the unknown nodes by applying extended Kalman filter to distance information between each of the unknown nodes and each of the anchor nodes, distance information between the unknown nodes and coordinate information of each of the anchor nodes. Hereinafter, a method of calculating the coordinates of each of the unknown nodes using extended Kalman filter according to this embodiment is described with reference to FIG. 2.

In this embodiment, the state vector x of the extended Kalman filter may be expressed as Mathematical Equation 4, and the measurement vector z thereof may be expressed by Mathematical Equation 5:

$$x = {[ \begin{matrix}P \\ V\end{matrix} ]}_{2 {dN}_{U} \times 1} \qquad [ Mathematical Equation 4 ]$$

where P represents a position, and V represents a velocity.

$$Z = {[ \begin{matrix}{R}_{m 1} \\ {R}_{m 2} \\ {\dot{R}}_{m 1} \\ {\dot{R}}_{m 2} \\ {V}_{m}\end{matrix} ]}_{( 2 ( {N}_{A} {N}_{U} + \frac{{N}_{U} ( {N}_{U} - 1 )}{2} ) + {dN}_{U} ) \times 1} \qquad [ Mathematical Equation 5 ]$$

Rₘ is a vector representing a distance measurement, \dot{R}ₘ is a vector where representing a differential measurement of the distance, Vₘ is a vector representing a velocity measurement of an unknown node, and the equations consisting of the equations consisting of N_{A} and N_{U} represent the sizes of each matrix and vector. In addition, in Rₘ₁ and \dot{R}ₘ₁, “1” represents a distance between an unknown node and an anchor node, and in Rm2 and \dot{R}ₘ₂, “2” represents a distance between unknown nodes. For convenience of explanation, components of the measurement vector z are limited to a distance measurement, a differential measurement of the distance and a velocity measurement in an embodiment of the present invention, but are not limited thereto. The components of the measurement vector z may vary depending on the type of measurement value that can be updated and the measurement cycle.

Meanwhile, the measurement vector z is expressed as the following Mathematical Equation 6 for the state vector x:

$$Z = h ( x ) + v \qquad [ Mathematical Equation 6 ]$$

where h (x) represents an estimate calculated using the state vector to calculate an error from a measured value, and may be expressed as

$$h ( x ) = {[ \begin{matrix}{R}_{1} \\ {R}_{2} \\ {\dot{R}}_{1} \\ {\dot{R}}_{2} \\ V\end{matrix} ]}_{( 2 ( {N}_{A} {N}_{U} + \frac{{N}_{U} ( {N}_{U} - 1 )}{2} ) + {N}_{U} ) \times 1} .$$

That is, a distance and its derivative are calculated using the position and velocity estimates, and the velocity estimate is used directly in the error calculation.

If Equation 6, a nonlinear model, is linearized using Jacobian, it becomes Equation 7:

$$H = \frac{\partial h}{\partial x} {\vert}_{\hat{x}} \qquad [ Mathematical Equation 7 ]$$

Hereinafter, a method of correcting an error in the position and velocity of an unknown node using the extended Kalman filter according to this embodiment is described.

The coordinate calculation part 130 predicts position errors and velocity errors of unknown nodes, which are errors of a state to be estimated, through the state transition matrix (Mathematical Equation 8), and predicts an error covariance through the state transition matrix (Mathematical Equation 9):

$$δ {\hat{x}}^{-} ( k + 1 ) = {F}_{d} ( k ) δ {\hat{x}}^{+} ( k ) \qquad [ Mathematical Equation 8 ]$$

$${P}^{-} ( k + 1 ) = {F}_{d} ( k ) {P}^{-} ( k ) {F}_{d}^{T} ( k ) + {W}_{d} ( k ) \qquad [ Mathematical Equation 9 ]$$

The coordinate calculation part 130 utilizes the error covariance predicted through Mathematical Equation 9 to calculate a Kalman gain as in Mathematical Equation 10. That is, the coordinate calculation part 130 calculates errors between the calculated values and the obtained information using the estimated state values, and calculates a Kalman gain according to the reliability of the obtained information and the calculated error covariance (Mathematical Equation 10):

$$K = {P}^{-} {{H}^{T} ( H {P}^{-} {H}^{T} + V )}^{- 1} \qquad [ Mathematical Equation 10 ]$$

In addition, the coordinate calculation part 130 calculates a weight for how much to trust the information obtained using the Kalman gain, as shown in Mathematical Equation 11 below:

$$δ {\hat{x}}^{+} = δ {\hat{x}}^{-} + K ( h - z ) \qquad [ Mathematical Equation 11 ]$$

That is, in Mathematical Equation 11, the coordinate calculation part 130 estimates a position error and velocity error of the unknown node by applying a weight according to the Kalman gain (K) to an error between the estimated value (h), calculated from the estimated position and velocity (x) of the unknown node, and the acquired measurement value (z).

Meanwhile, when an unknown node is a camera, the information acquisition part 120 acquires distance and angle information between each of the unknown nodes and each of the anchor nodes, distance information between the unknown nodes and coordinate information of each of the anchor nodes.

The coordinate calculation part 130 calculates the coordinates of each of the unknown nodes based on distance and angle information between each of the unknown nodes and each of the anchor nodes, distance information between the unknown nodes and coordinate information of each of the anchor nodes.

In addition, the coordinate calculation part 130 may calculate the coordinates of each of the unknown nodes by assigning different weights to each of distance and angle information between each of the unknown nodes and each of the anchor nodes, distance information between the unknown nodes and coordinate information of each of the anchor nodes (weighted least square). A method of calculating the coordinates of each of the unknown nodes using the weighted least square when an unknown node is a camera is the same as in the above-described case where an unknown node is a sensor apparatus, so a description thereof is omitted.

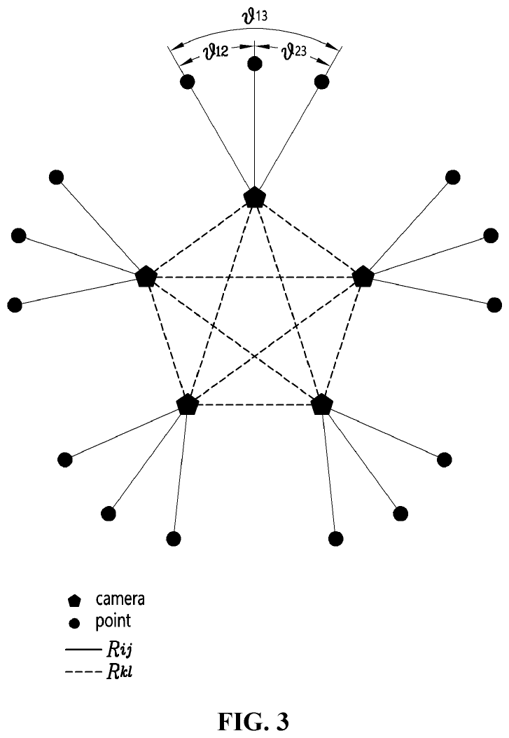

In addition, the coordinate calculation part 130 may estimate the coordinates of each of the unknown nodes by applying the extended Kalman filter to distance and angle information between each of the unknown nodes and each of the anchor nodes, distance information between the unknown nodes and coordinate information of each of the anchor nodes. Hereinafter, the method of calculating the coordinates of each of the unknown nodes using the extended Kalman filter in multiple camera positioning according to this embodiment is described with reference to FIG. 3.

In this embodiment, a positional relationship between an anchor node and an unknown node may be expressed as Mathematical Equation 12, and a positional relationship between an unknown node and an unknown node may be expressed as Mathematical Equation 13:

$${θ}_{i}^{m , n} = arccos ( \frac{{R}_{i}^{{m}^{2}} + {R}_{í}^{{n}^{2}} - {R}_{i}^{mn}}{2 {R}_{i}^{m} {R}_{i}^{m}} ) \qquad [ Mathematical Equation 12 ]$$

$$\begin{matrix}i : 1 , … , {N}_{c} \\ m : 1 , … , {N}_{P} - 1 \\ n : 2 , … , {N}_{P} ( l > k )\end{matrix}$$

$${R}_{kl} = \vert {\vec{P}}_{k} - {\vec{P}}_{l} \vert \qquad [ Mathematical Equation 13 ]$$

$$\begin{matrix}k : 1 , … , {N}_{C} - 1 \\ l : 2 , … , {N}_{C} ( l > k )\end{matrix}$$

where R represents a distance, P represents a position, θ represents an angle, Nc represents the number of cameras, and N_{P} represents the number of matching points per camera.

In this embodiment, the state vector x of the extended Kalman filter may be expressed as Mathematical Equation 14, and the measurement vector z may be expressed as Mathematical Equation 15:

$$x = {[ \begin{matrix}P \\ V\end{matrix} ]}_{2 {dN}_{U} \times 1} \qquad [ Mathematical Equation 14 ]$$

where P represents a position, and V represents a velocity.

$$z = {[ \begin{matrix}{θ}_{m} \\ {R}_{m 2} \\ {V}_{m}\end{matrix} ]}_{( {N}_{C} \frac{( {N}_{P} - 1 ) {N}_{P}}{2} + \frac{{N}_{C} ( {N}_{C} - 1 )}{2} + {dN}_{U} ) \times 1} \qquad [ Mathematical Equation 15 ]$$

where θ ₘ is a vector representing an angle measurement value, Rₘ is a vector representing a distance measurement, Vₘ is a vector representing a velocity measurement of an unknown node, and the equations of N_{C}, N_{P} and N_{U} represent the sizes of each matrix and vector. In addition, in Rₘ₂, “2” represents a distance between unknown nodes. For convenience of explanation, components of the measurement vector z are limited to an angle measurement, a distance measurement and a velocity measurement in an embodiment of the present invention, but are not limited thereto. The components of the measurement vector z may vary depending on the type of measurement value that can be updated and the measurement cycle.

Meanwhile, the measurement vector z is expressed as the following Mathematical Equation 16 for the state vector x:

$$Z = h ( x ) + v \qquad [ Mathematical Equation 16 ]$$

where h(x) represents an estimate calculated using the state vector to calculate an error from a measured value, and may be expressed as

$$h ( x ) = {[ \begin{matrix}θ \\ {R}_{2} \\ V\end{matrix} ]}_{( {N}_{C} \frac{( {N}_{P} - 1 ) {N}_{P}}{2} + \frac{{N}_{C} ( {N}_{C} - 1 )}{2} + {dN}_{U} ) \times 1} .$$

That is, a distance and an angle are calculated using a position estimate, and the velocity estimate is used directly in the error calculation.

If Equation 16, a nonlinear model, is linearized using Jacobian, it becomes Equation 7.

Hereinafter, a method of correcting an error in the position and velocity of an unknown node using the extended Kalman filter according to this embodiment is described.

The coordinate calculation part 130 predicts position errors and velocity errors of unknown nodes, which are errors of a state to be estimated, through the state transition matrix through Mathematical Equation 8 described above, and predicts an error covariance through the state transition matrix through Mathematical Equation 9 described above.

The coordinate calculation part 130 utilizes the error covariance predicted through Mathematical Equation 9 to calculate a Kalman gain through Mathematical Equation 10 described above. That is, the coordinate calculation part 130 calculates errors between the calculated values and the obtained information using the estimated state values, and calculates a Kalman gain according to the reliability of the obtained information and the calculated error covariance.

In addition, the coordinate calculation part 130 calculates a weight for how much to trust the information obtained using the Kalman gain through Mathematical Equation 11 described above. That is, the coordinate calculation part 130 estimates a position error and velocity error of the unknown node by applying a weight according to the Kalman gain (K) to an error between the estimated value (h), calculated from the estimated position and velocity (x) of the unknown node, and the acquired measurement value (z).

When the coordinates of each of the unknown nodes are calculated using extended Kalman filter, and when the number of matching points is equal to 4 or more in multiple camera positioning using angle information, there is more angle information than distance information and the angle information is coupled information, so the degree of improvement in position error calculated using angle information may further increase as the number of matching points increases.

Hereinafter, the specific configuration of the multiple positioning apparatus according to the present invention is described.

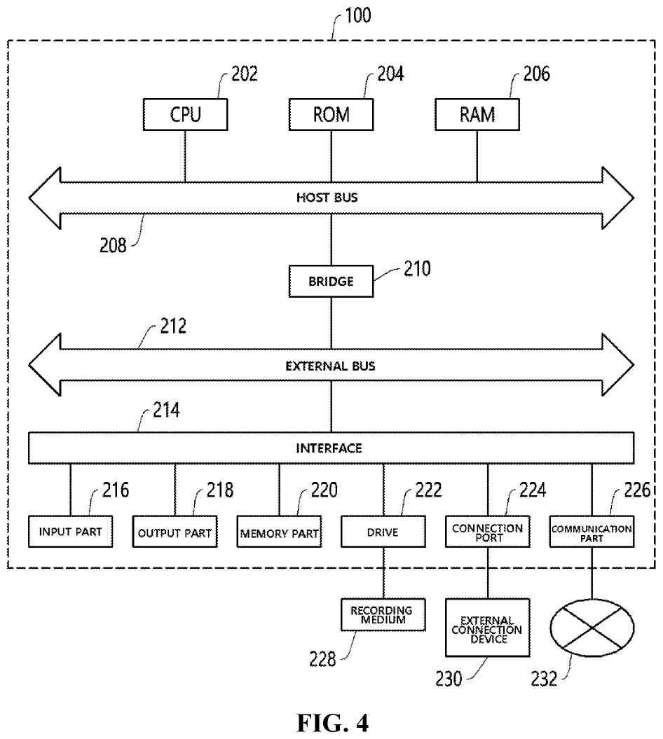

Referring to FIG. 4, hardware capable of realizing the functions of the multiple positioning apparatus is described. FIG. 4 is a block diagram illustrating an example of hardware capable of realizing the function of a multiple positioning apparatus according to an embodiment of the present invention.

The functions of the multiple positioning apparatus 100 may be realized, for example, using hardware resources shown in FIG. 4. That is, the functions of the multiple positioning apparatus 100 are realized by controlling the hardware shown in FIG. 4 using a computer program.

As shown in FIG. 4, this hardware mainly includes CPU 202, Read Only Memory (ROM) 204, RAM 206, a host bus 208, and a bridge 210. In addition, this hardware includes an external bus 212, an interface 214, an input part 216, an output part 218, a memory part 220, a drive 222, a connection port 224, and a communication part 226.

The CPU 202 functions, for example, as an arithmetic processing apparatus or a control apparatus to control all or part of the operation of each component based on various programs recorded in the ROM 204, the RAM 206, the memory part 220, or the removable recording medium 228. The ROM 204 is an example of a memory apparatus that stores programs read by the CPU 202 and data used for calculations. In the RAM 206, for example, programs read by the CPU 202, or various parameters that change when executing the program are temporarily or permanently stored.

These elements are connected to each other, for example, via the host bus 208 that allows high-speed data transfer. Meanwhile, the host bus 208 is connected, for example, to the external bus 212, which has a relatively low data transmission velocity, through the bridge 210. In addition, for example, a mouse, a keyboard, a touch panel, a touch pad, a button, a switch, a lever, or the like is used as the input part 216. In addition, a remote controller capable of transmitting control signals using infrared rays or other radio waves may be used as the input part 216.

For example, a display apparatus such as a Cathode Ray Tube (CRT), a Liquid Crystal Display (LCD), a Plasma Display Panel (PDP), or an Electro-Luminescence Display (ELD) may be used as the output part 218. In addition, an audio output device such as a speaker or headphone, a printer, or the like may be used as the output part 218.

The memory part 220 is a device for storing various data. For example, a magnetic storage device such as HDD is used as the memory part 220. In addition, a semiconductor storage device such as a Solid State Drive (SSD) or a RAM disk, an optical memory device, a magneto-optical storage device, or the like may be used as the memory part 220.

The drive 222 is a device that reads information recorded on the removable recording medium 228, which is a removable recording medium, or records information on the removable recording medium 228. As the removable recording medium 228, for example, a magnetic disk, an optical disk, a magneto-optical disk, or a semiconductor memory is used. In addition, a program defining the operation of the multiple positioning apparatus 100 may be stored in the removable recording medium 228.

The connection port 224 is a port for connecting an external connection device 230, such as, for example, a Universal Serial Bus (USB) port, IEEE 1394 port, a Small Computer System Interface (SCSI), RS-232C port, or an optical audio terminal. As the external connection device 230, for example, a printer, etc. is used.

The communication part 226 is a communication device for connecting to a network 232. As the communication part 226, for example, a communication circuit for a wired or wireless LAN, a communication circuit for a WUSB (Wireless USB), a communication circuit for a mobile phone network, etc. may be used. The network 232 is, for example, a network connected by wire or wireless.

The hardware of the multiple positioning apparatus 100 has been described above. In addition, the hardware described above is an example, and modifications such as omitting some elements or adding new elements may be made.

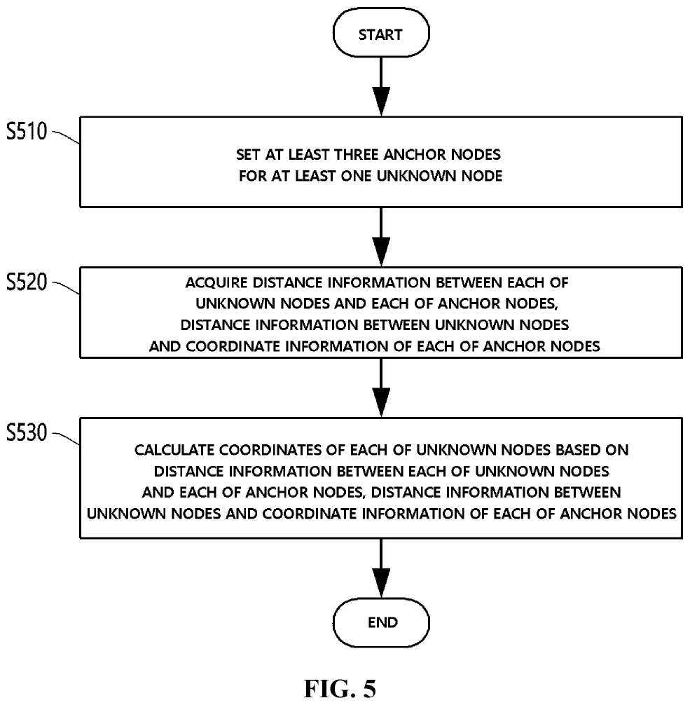

FIG. 5 is a flowchart illustrating a multiple positioning method when the unknown node according to an embodiment of the present invention is a sensor apparatus.

Referring to FIG. 5, the multiple positioning apparatus 100 sets at least three anchor nodes whose positions are known to at least one unknown node whose position is to be obtained (S510).

The multiple positioning apparatus 100 acquires distance information between each of the unknown nodes and each of the anchor nodes, distance information between the unknown nodes and coordinate information of each of the anchor nodes (S520).

The multiple positioning apparatus 100 calculates the coordinates of each of the unknown nodes based on distance information between each of the unknown nodes and each of the anchor nodes, distance information between the unknown nodes and coordinate information of each of the anchor nodes (S530). Here, the multiple positioning apparatus 100 may calculate the coordinates of each of the unknown nodes by assigning different weights to each of distance information between each of the unknown nodes and each of the anchor nodes, distance information between the unknown nodes and coordinate information of each of the anchor nodes. In addition, the multiple positioning apparatus 100 may estimate the coordinates of each of the unknown nodes by applying the extended Kalman filter to distance information between each of the unknown nodes and each of the anchor nodes, distance information between the unknown nodes and coordinate information of each of the anchor nodes.

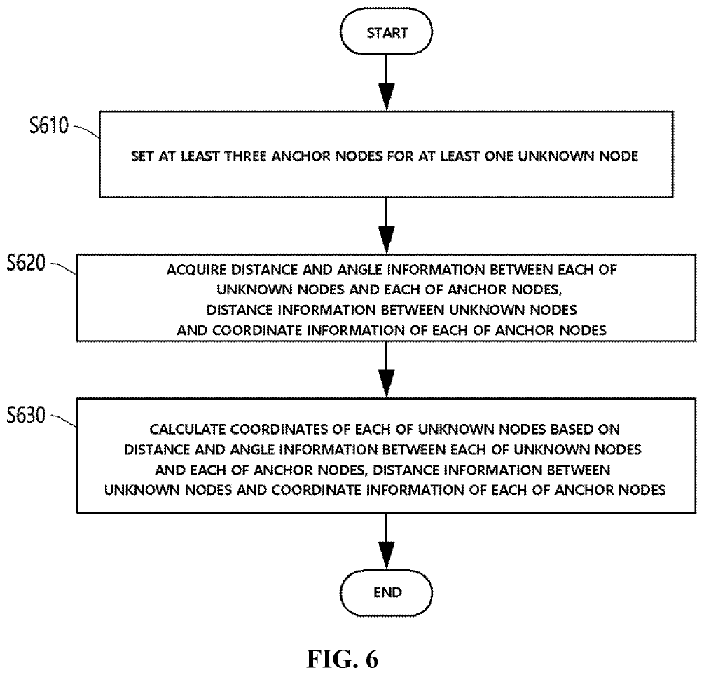

FIG. 6 is a flowchart illustrating a multiple positioning method when an unknown node according to an embodiment of the present invention is a camera.

Referring to FIG. 6, the multiple positioning apparatus 100 sets at least three anchor nodes whose positions are known to at least one unknown node whose position is to be obtained (S610).

The multiple positioning apparatus 100 acquires distance and angle information between each of the unknown nodes and each of the anchor nodes, distance information between the unknown nodes and coordinate information of each of the anchor nodes (S620).

The multiple positioning apparatus 100 calculates the coordinates of each of the unknown nodes based on distance and angle information between cach of the unknown nodes and each of the anchor nodes, distance information between the unknown nodes and coordinate information of cach of the anchor nodes (S630). Here, the multiple positioning apparatus 100 may calculate the coordinates of each of the unknown nodes by assigning different weights to each of distance information between each of the unknown nodes and each of the anchor nodes, distance information between the unknown nodes and coordinate information of each of the anchor nodes. In addition, the multiple positioning apparatus 100 may estimate the coordinates of each of the unknown nodes by applying the extended Kalman filter to distance and angle information between cach of the unknown nodes and each of the anchor nodes, distance information between the unknown nodes and coordinate information of each of the anchor nodes.

The method of the present invention described above may be achieved by various means. For example, hardware, firmware, software, or a combination thereof.

In a hardware configuration, an embodiment of the present invention may be achieved by one or more application-specific integrated circuits (ASICs), digital signal processors (DSPs), digital signal processing devices (DSDPs), programmable logic devices (PLDs), field programmable gate arrays (FPGAs), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

The multiple positioning apparatus 100 according to the present invention may be applied to all objects, whose mutual distance can be known, including an object, car, robot, drone, aircraft, ship, and people equipped with distance sensors. In addition, the present invention may be applied to all existing positioning methods such as UWB, BLE, and WiFi including GNSS.

In addition, the multiple positioning apparatus 100 according to the present invention may also be applied to camera positioning using multiple cameras. Applicable targets may be multiple camera modules configured only for positioning, cameras mounted on cars, robots and drones, etc., or individual cameras equipped with sensors that can determine mutual distance.

The embodiments disclosed in the present specification have been described with reference to the attached drawings. The embodiments shown in each drawing should not be construed as limited, but may be combined with each other by those skilled in the art who are familiar with the contents of the present specification, and when combined, it may be interpreted that some components may be omitted.

The terms and words which are used in the present specification and the appended claims should not be construed as being confined to common meanings or dictionary meanings but should be construed as meanings and concepts matching the technical spirit of the present invention.

Accordingly, the constructions of examples and drawings disclosed in the present specification are merely embodiments of the present invention and do not represent the full technical spirit disclosed in the specification of the present invention. Therefore, it should be understood that various equivalents and modifications may have been present at a filling time of the present application.

### Description of Symbols

1. A multiple positioning apparatus, comprising:
a node setting part for setting at least three anchor nodes whose positions are known to at least one unknown node whose position is to be obtained;
an information acquisition part for acquiring distance information between each of unknown nodes and each of anchor nodes, distance information between unknown nodes and coordinate information of each of anchor nodes; and
a coordinate calculation part for calculating coordinates of each of the unknown nodes based on the distance information between each of the unknown nodes and each of the anchor nodes, the distance information between the unknown nodes and the coordinate information of each of the anchor nodes.

2. The multiple positioning apparatus according to claim 1, wherein each of the unknown nodes is a sensor apparatus.

3. The multiple positioning apparatus according to claim 1, wherein the coordinate calculation part calculates coordinates of each of the unknown nodes by assigning different weights to each of the distance information between each of the unknown nodes and each of the anchor nodes, the distance information between the unknown nodes and the coordinate information of each of the anchor nodes.

4. The multiple positioning apparatus according to claim 1, wherein the coordinate calculation part estimates coordinates of each of the unknown nodes by applying extended Kalman filter to the distance information between each of the unknown nodes and each of the anchor nodes, the distance information between the unknown nodes and the coordinate information of each of the anchor nodes.

5. A multiple positioning apparatus, comprising:
a node setting part for setting at least three anchor nodes whose positions are known to at least one unknown node whose position is to be obtained;
an information acquisition part for acquiring distance and angle information between each of unknown nodes and each of anchor nodes, distance information between unknown nodes and coordinate information of each of anchor nodes; and
a coordinate calculation part for calculating coordinates of each of the unknown nodes based on the distance and angle information between each of the unknown nodes and each of the anchor nodes, the distance information between the unknown nodes and the coordinate information of each of the anchor nodes.

6. The multiple positioning apparatus according to claim 5, wherein each of the unknown nodes is a camera.

7. The multiple positioning apparatus according to claim 6, wherein each of the anchor nodes represents specific points in an image captured by the camera.

8. The multiple positioning apparatus according to claim 5, wherein the coordinate calculation part calculates coordinates of each of the unknown nodes by assigning different weights to each of the distance information between each of the unknown nodes and each of the anchor nodes, the distance information between the unknown nodes and the coordinate information of each of the anchor nodes.

9. The multiple positioning apparatus according to claim 5, wherein the coordinate calculation part estimates coordinates of each of the unknown nodes by applying extended Kalman filter to the distance and angle information between each of the unknown nodes and each of the anchor nodes, the distance information between the unknown nodes and the coordinate information of each of the anchor nodes.

10. A multiple positioning method, comprising:
setting, by a multiple positioning apparatus, at least three anchor nodes whose positions are known to at least one unknown node whose position is to be obtained;
acquiring, by the multiple positioning apparatus, distance information between each of unknown nodes and each of anchor nodes, distance information between unknown nodes and coordinate information of each of anchor nodes; and
calculating, by the multiple positioning apparatus, calculating coordinates of each of the unknown nodes based on the distance information between each of the unknown nodes and each of the anchor nodes, the distance information between the unknown nodes and the coordinate information of each of the anchor nodes.
